(19) United States
(12) Patent Application Publication
(10) Pub. No.: US 2021/0056270 A1
(43) Pub. Date: Feb. 25, 2021

(54) ELECTRONIC DEVICE AND DEEP LEARNING-BASED INTERACTIVE MESSENGER OPERATION METHOD

(71) Applicant: Samsung Electronics Co., Ltd., Suwon-si (KR)

(72) Inventors: Wael Younis FARHAN, Amman (JO); Analle Jamal ABUAMMAR, Amman (JO); Ruba Waleed JAIKAT, Amman (JO)

(21) Appl. No.: 16/997,319

(22) Filed: Aug. 19, 2020

(30) Foreign Application Priority Data
Aug. 20, 2019 (KR) 10-2019-0101936

(51) Int. Cl. G06F 40/56; G06F 40/295; G06F 16/335; G06N 3/04; H04L 12/58

(52) U.S. Cl. CPC G06F 40/56; G06F 40/295; H04L 51/02; G06N 3/04; G06F 16/337

(57) ABSTRACT

An interactive messenger operation method may include: transferring a user's sentence or comment to an interactive messenger architecture; generating candidate responses by means of a response generator, based on a user language model and a context; and selecting one response from among the candidate responses through a ranking network by using a personal database and a user vector embedding.

### CROSS-REFERENCE TO RELATED APPLICATION

This application is based on and claims priority under 35 U.S.C. 119 to Korean Patent Application No. 10-2019-0101936, filed on Aug. 20, 2019, in the Korean Intellectual Property Office, the disclosure of which is herein incorporated by reference in its entirety.

### BACKGROUND

### 1. Field

Various embodiments of the disclosure relate to a deep learning-based interactive messenger operation method and an electronic device including the operation method.

### 2. Description of Related Art

An interactive messenger, such as a chatbot, a talkbot, and a chatterbot, has conventionally been able to respond to a user through a messenger, based on a predetermined response rule.

Due to the development of data analysis technology and artificial intelligence technology, an interactive messenger can reply by talking with a human in everyday language. In spite of the artificial intelligence technology, since an existing interactive messenger replies within a predefined response group, there is a problem in which the formation of a new sentence is impossible, and since the same personality is provided to a chatbot, there is a disadvantage in which the chatbot cannot reflect personalities of various users and cannot detect language and vocabulary that a user frequently uses.

The above information is presented as background information only to assist with an understanding of the disclosure. No determination has been made, and no assertion is made, as to whether any of the above might be applicable as prior art with regard to the disclosure.

### SUMMARY

An electronic device and a deep learning-based interactive messenger operation method according to various embodiments can learn a user's personality, interest, language, and sentiment.

An electronic device and a deep learning-based interactive messenger operation method according to various embodiments can infinitely generate new sentences in accordance with a user's input.

An electronic device and a deep learning-based interactive messenger operation method according to various embodiments can generate a new personality for each user, based on a conversation with the user.

An electronic device and a deep learning-based interactive messenger operation method according to various embodiments can use language which is similar to language and vocabulary that a user uses.

An interactive messenger operation method according to various embodiments may include: transferring a user's sentence or comment to an interactive messenger architecture; generating candidate responses by means of a response generator, based on a user language model and a context; and selecting one response from among the candidate responses through a ranking network by using a personal database and a user vector embedding.

An electronic device according to various embodiments includes: a display device; a communication module; a memory; and a processor, wherein the processor may: transfer a user's sentence or comment to an interactive messenger architecture; generate candidate responses by means of a response generator, based on a user language model and a context; and select one response from among the candidate responses through a ranking network by using a personal database and a user vector embedding.

An electronic device and a deep learning-based interactive messenger operation method according to various embodiments can provide a user with a specialized performance function by learning a user's personality, interest, language, and sentiment.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the disclosure and its advantages, reference is now made to the following description taken in conjunction with the accompanying drawings, in which like reference numerals represent like parts:

FIG. 1 is a block diagram illustrating an electronic device in a network environment, according to various embodiments;

FIG. 2 is a diagram illustrating an interactive messenger operation on an electronic device according to various embodiments;

FIG. 3 is a diagram illustrating an interactive messenger architecture included in an electronic device or a server of the disclosure;

FIG. 4 illustrates a dimensional expansion according to the weight of a user vector embedding according to various embodiments;

FIG. 5A illustrates a method for obtaining the similarity from a user's input, language, and/or utterance of a user vector embedding according to various embodiments;

FIG. 5B illustrates a characteristic of each user as a vector space, based on a user's input, language, and/or utterance of a user vector embedding according to various embodiments;

FIG. 6 is a diagram illustrating a response generator according to various embodiments;

FIG. 7 illustrates an operation of a named entity recognition according to various embodiments;

FIG. 8 illustrates an operation of a ranking network according to various embodiments;

FIG. 9 illustrates an operation of an information retrieval unit according to various embodiments;

FIG. 10 is a flowchart illustrating an operation of an electronic device which can communicate with a server according to various embodiments;

FIG. 11 is a flowchart illustrating an operation of a server which can communicate with an electronic device according to various embodiments; and

FIG. 12 is a flowchart illustrating an operation of an electronic device according to various embodiments.

### DETAILED DESCRIPTION

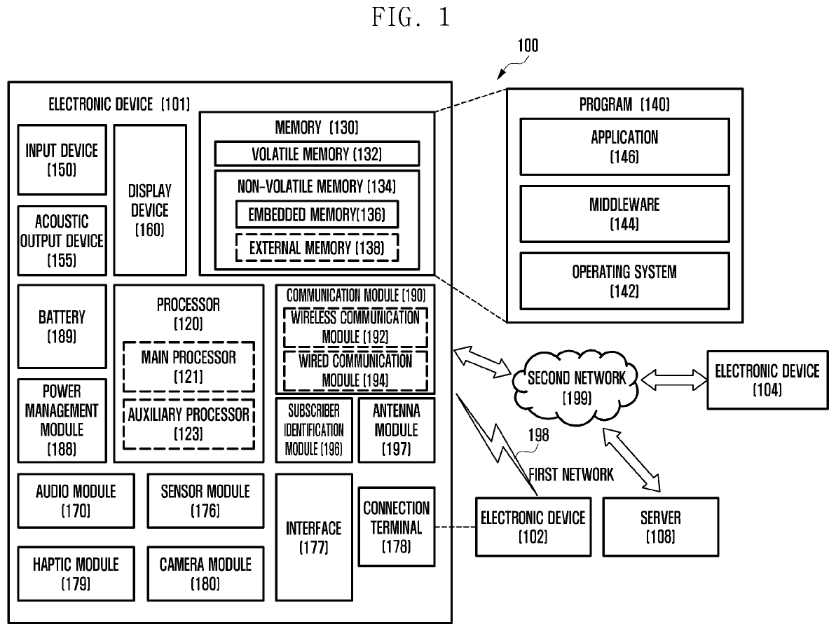

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

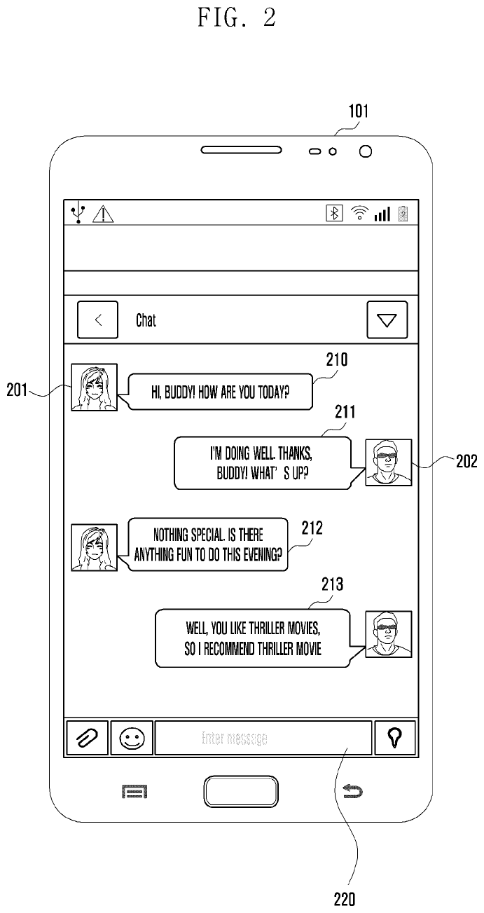

FIG. 2 is a diagram illustrating an interactive messenger operation on the electronic device 101 according to various embodiments.

The electronic device 101 displays an execution screen of an interactive messenger. The interactive messenger may include an interface, and include an input window 220 for text input of a user 201 and/or an interface for voice input. When the interactive messenger is executed, a chatbot 202 may be displayed to the user 201 as an interface in order to enable an intuitive conversation. The interface of the interactive messenger may display a conversation between the user 201 and the chatbot 202 in a message bubble or message window form.

When in operation 210, the user 201 inputs “Hi, buddy! How are you today?” by voice and/or text, the chatbot 202 may respond with “I'm doing well. Thanks, buddy! What's up?” by voice and/or text in operation 211. The chatbot 202 may respond by using an expression “buddy” which is language or vocabulary that the user 201 uses.

When in operation 212, the user 201 inputs “Nothing special. Is there anything fun to do this evening?” by voice and/or text, the chatbot 202 may respond with “Well, you like thriller movies, so I recommend a thriller movie.” by voice and/or text in operation 213.

The chatbot 202 may respond by detecting the personality, sentiment, or interest of the user 201. The chatbot 202 may respond by detecting the bored feeling of the user 201 and the characteristic or personality that the user 201 is interested in thriller movies.

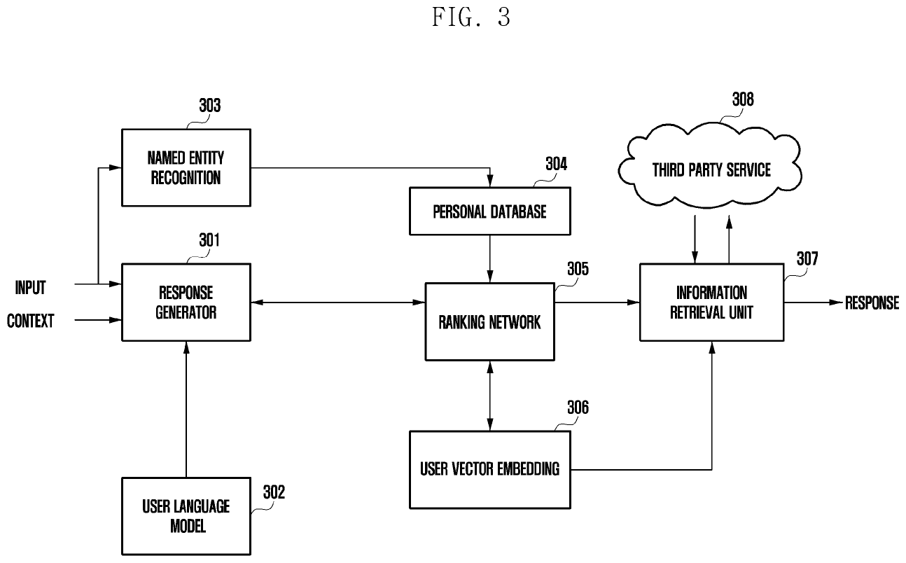

FIG. 3 is a diagram illustrating an interactive messenger architecture 300 included in the electronic device 101 or the server 108 of the disclosure.

The interactive messenger architecture 300 may include: a response generator 301; a user language model 302; a named entity recognition 303; a personal database 304; a ranking network 305; a user vector embedding 306; an information retrieval unit 307; and a third party service 308.

The interactive messenger architecture 300 may be stored in a memory (for example, the memory 130) of the electronic device 101 or the server 108. The interactive messenger architecture 300 may be embedded in a processor (for example, the processor 120) of the electronic device 101 or the server 108.

When a user inputs or utters something, the interactive messenger architecture 300 may transfer the user's input to the named entity recognition 303 and the response generator 301.

The response generator 301 may generate candidate responses by using a hierarchical recurrent encoder decoder (HRED)-based sequence to sequence deep neural network and the user language model 302, and transfer the candidate responses to the ranking network 305.

The response generator 301 may include the HRED-based sequence to sequence deep neural network.

A hierarchical recurrent encoder decoder (HRED) included in the response generator 301 may obtain a response to the current input while remembering the user's previous input and a content of the past conversation.

The HRED included in the response generator 301 may operate based on an encoder, a decoder, and a context.

The encoder may process a content currently input by the user and remember what the user utters by splitting the user's input into words and successively receiving the words.

The decoder may generate a response appropriate for the user's input, based on information remembered by the context, and successively generate a response for each of the words.

The context may perform a role for remembering the user's past conversation. The context may continuously remember a content of the user's input, which the encoder has processed so far, during the conversation. The context may remember the user's conversation context. The context may remember the user's past input information, add a content that the user inputs at a specific time point to the information, and then transfer the information to the decoder.

The HRED included in the response generator 301 may time-sequentially perform operations of storing the user's input and responding to the same.

The encoder of the HRED included in the response generator 301 may be equal to an encoder recurrent neural network (an encoder RNN) or an utterance encoder.

The decoder of the HRED included in the response generator 301 may be equal to a decoder recurrent neural network (a decoder RNN) or a response encoder.

The context of the HRED included in the response generator 301 may be equal to a context recurrent neural network (a context RNN).

The response generator 301 may generate a candidate response group while maintaining a context of the user's input by using the HRED-based sequence to sequence deep neural network.

The encoder of the HRED included in the response generator 301 may encode the language and/or vocabulary according to the user's input into a vector value.

The context of the HRED included in the response generator 301 may receive, as input, a vector value obtained by encoding the language and/or vocabulary according to the user's input and then converting the same. The context of the HRED included in the response generator 301 may receive, as input, a vector value obtained by encoding the language and/or vocabulary according to the user's input, and may update a hidden state in order to maintain the conversation context and store all pieces of information of the user's input.

The context of the HRED included in the response generator 301 may transfer an output having the vector value to the decoder.

The decoder of the HRED included in the response generator 301 may receive an input having the vector value from the context and generate a response thereto.

When the response generator 301 generates a response, the response generator may use the user language model 302. The user language model 302 may stochastically predict text or a sequence of words. When a candidate response group is generated by the decoder of the HRED included in the response generator 301, the user language model 302 enables the generation of the candidate response group by giving, based on the probability, increased weights to input, language, and/or utterance that the user has used.

A language model used for the user language model 302 may be a method using an artificial neural network and/or a method using statistics or the probability. For example, the language model may be a unigram model, a bigram model, a trigram model, or an N-gram model.

The user language model 302 may perform an update such that increased weights are given to the input, language, and/or utterance that the user has used, in the candidate response group output from the decoder of the HRED included in the response generator 301.

As the user language model 302 provides the weight to a specific user who uses the interactive messenger architecture 300 or the user's input, language, and/or utterance, the interactive messenger architecture 300 may generate a response, based on the language that the user frequently uses. The user language model 302 may separate, store, and update the weight for each user who uses the interactive messenger architecture 300.

When the user inputs or utters something, the interactive messenger architecture 300 may transfer the input to the named entity recognition 303 and the response generator 301.

The named entity recognition 303 may extract and recognize a named entity from the user's input, language, and/or utterance. For example, the named entity recognition 303 may use an intermediate-beginning-object (IBO) format. The named entity recognition 303 may extract and recognize a movie title, a human name, a music title, a place name, an organization title, time, points of interest (POI), or the like from the user's input, language, and/or utterance. For example, a method for recognizing, by the named entity recognition 303, a named entity in the IBO format may be as follows. When a named entity with respect to a human name is extracted from the user's input, language, and/or utterance such as “Michael Jackson visits”, “Mi”, namely a start of a human name, may be expressed as “B” and the rest of the human name may be expressed as “I” until the end of the human name, in the IBO format. A part that is not the human name may be expressed as “O”. Specifically, “Mi” may be expressed as “B”, “chael”, “Jack”, and “son” may be expressed as “I”, and “visits” may be expressed as “O”.

The named entity recognition 303 may be a sequence labelling network including a long short term memory (LSTM) and a conditional random field (CRF) layer.

The LSTM included in the named entity recognition 303 may be a bi-direction long short term memory (LSTM).

The LSTM adds an input gate, an oblivion gate, and an output gate to a memory cell of a hidden layer of a recurrent neural network so as to remove an unnecessary memory, and decide a memory that should be remembered. In the LSTM, a formula for calculating a hidden state is a little more complicated than that of a traditional recurrent neural network and additionally includes a value called a cell state The bi-direction LSTM may be a model in which an LSTM layer expands not only forward but also backward. In addition, the named entity recognition 303 may improve named entity recognition by enabling the CRF layer to be included in an encoding end of the LSTM.

When the named entity recognition 303 extracts and recognizes a named entity from the user's input, language, and/or utterance, the recognized named entity may be transferred to the personal database 304.

The named entity having been recognized by the named entity recognition 303 may reflect the user's language, sentiment, personality, and behavior. The personal database 304 may include not only a named entity but also user data.

The user data may be data derived from an electronic device (for example, the electronic device 101) used by the user or the user's input, language, and/or utterance, and the user data may reflect various information such as the user's favorite music, movie, hobby, interest, and sports, and is not limited thereto. The personal database 304 may separate and manage the user data and the recognized named entity for each interactive messenger user.

The ranking network 305 may select a response from the candidate response group having been generated by the response generator 301, based on the user vector embedding 306 and the user data and the recognized named entity of the personal database 304.

When the ranking network selects a response from the generated candidate response group, the ranking network 305 may use the user vector embedding 306. For example, the user vector embedding 306 may employ a word2vec or one-hot encoding method.

The user vector embedding 306 may determine the similarity between responses, based on the response having been selected by the ranking network 305. The user vector embedding 306 may be separated and managed for each interactive messenger user. The user vector embedding 306 may perform an update operation, based on the response having been selected by the ranking network 305.

The user vector embedding 306 determines the similarity between responses, based on the response having been selected by the ranking network 305, and may thus provide the ranking network 305 with a basis for determining the conversation continuity of the user's behavior, interest, and sentiment, based on the user's input, language, and/or utterance.

When the ranking network 305 selects a response from the candidate response group having been generated by the response generator 301, the selected response is transferred to the information retrieval unit 307.

When it is determined that external information is necessary, the information retrieval unit 307 may retrieve information by using the third party service 308, may select information from the retrieved information, based on the user vector embedding 306, and the user data and the recognized named entity of the personal database 304, and may add the selected information to the selected response so as to finally provide the user with the response.

When it is determined that external information is unnecessary, the information retrieval unit 307 may add the selected information to the response having been selected by the ranking network 305 so as to finally provide the user with the response.

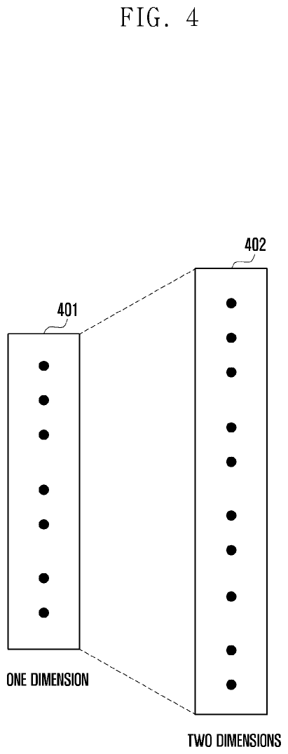

FIG. 4 illustrates a dimensional expansion according to the weight of the user vector embedding 306 according to various embodiments.

When the response having been previously selected by the ranking network 305 is a first-dimensional vector 401, the user vector embedding 306 may obtain a second-dimensional vector 402 by multiplying the first-dimensional vector by the weight (W) according to the similarity, so as to perform an update operation.

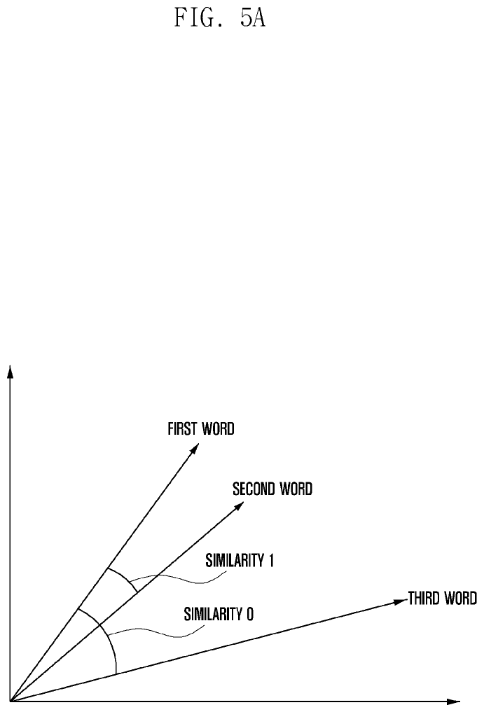

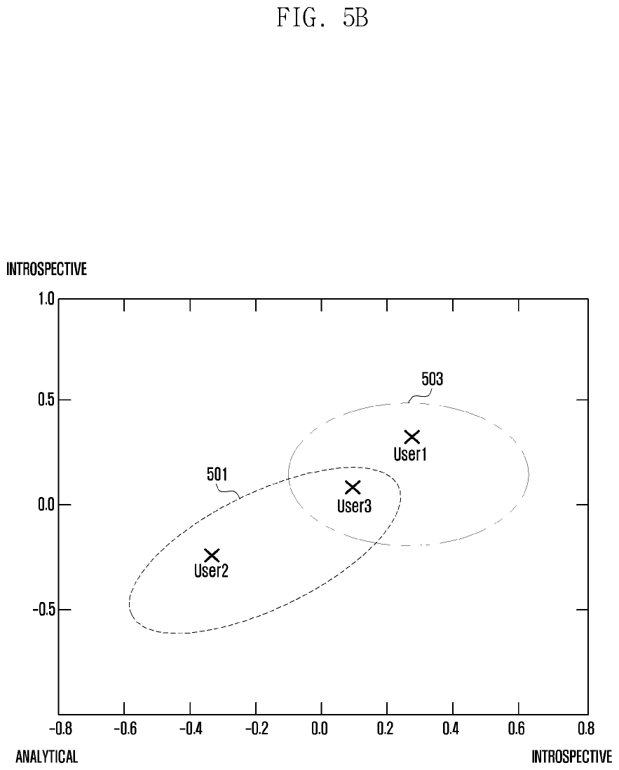

FIG. 5A illustrates a method for obtaining the similarity from the user's input, language and/or utterance of the user vector embedding 306 according to various embodiments.

The user's input, language, and/or utterance are obtained as vector values, and the user vector embedding 306 may determine that the similarity between the user's input, language, and/or utterance is high, by using a formula with respect to a trigonometric function such as [Equation 1], when a result value is close to 1, and may determine that the similarity between the user's input, language, and/or utterance is low when a result value is close to 0.

$$Similarity ( A , B ) = \frac{A \cdot B}{\vert A \vert \vert B \vert} \qquad [ Equation 1 ]$$

For example, the user vector embedding 306 may determine that the similarity between words is high when a result value between a first word and a second word is close to 1 by means of [Equation 1], and may determine that the similarity between words is low when a result value between the first word and a third word is close to 0.

FIG. 5B illustrates a characteristic of each user as a vector space, based on the user's input, language, and/or utterance of the user vector embedding 306 according to various embodiments.

In FIG. 5B, for description, a vector space is two-dimensionally expressed, but may actually be a space having one hundred dimensions or more.

User behaviors classified as group 501 may be a vector space group of users who analytically behave, and user behaviors classified as group 503 may be a vector space group of users who introspectively behave. The group 501 may include a second user and a third user of an interactive messenger and the group 503 may include a first user of an interactive messenger. The user vector embedding 306 may perform an update operation, based on the response having been selected by the ranking network 305, and may shift positions of the first to third users within the vector space, based on the update.

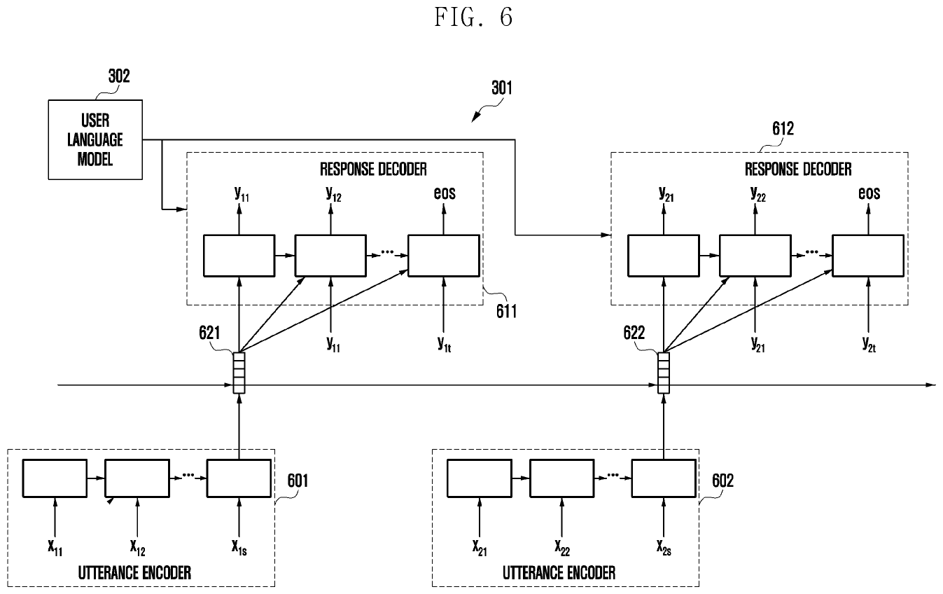

FIG. 6 is a diagram illustrating the response generator 301 according to various embodiments.

The response generator 301 may operate based on one or more utterance encoders 601 and 602, one or more response decoders 611 and 612, and one or more contexts 621 and 622.

The one or more utterance encoders 601 and 602 may process a content currently input by the user and remember what the user utters by splitting the user's input into words and successively receiving the words.

The one or more response decoders 611 and 612 may generate a response appropriate for the user's input, based on the information remembered by the context, and successively generate a response to each word.

The one or more contexts 621 and 622 may perform a role for remembering the user's past conversation. The contexts may continuously remember a content of the user's input, which the one or more utterance encoders 601 and 602 have processed so far, during the conversation. The one or more contexts 621 and 622 may remember the user's conversation context. The one or more contexts 621 and 622 may remember the user's past input information and add a content, which the user inputs at a specific time point, to the remembered information so as to transfer the information to the decoders.

The one or more utterance encoders 601 and 602 of the response generator 301 may encode the language and/or vocabulary according to the user's input into a vector value.

The one or more contexts 621 and 622 of the response generator 301 may receive, as input, a vector value obtained by encoding the language and/or vocabulary according to the user's input and then converting the same.

The one or more contexts 621 and 622 of the response generator 301 may receive, as input, a vector value obtained by encoding the language and/or vocabulary according to the user's input, and may update a hidden state in order to maintain the conversation context and store all pieces of information of the user's input.

The one or more contexts 621 and 622 of the response generator 301 may transfer outputs having vector values to the one or more response decoders 611 and 612.

The one or more response decoders 611 and 612 of the response generator 301 may receive inputs having vector values from the one or more contexts 621 and 622, and may generate responses.

When the response generator generates a response, the response generator 301 may use the user language model 302. The user language model 302 may stochastically predict text or a sequence of words. When a candidate response group is generated by the one or more response decoders 611 and 612 of the response generator 301, the user language model 302 enables the generation of the candidate response group by giving, based on the probability, increased weights to input, language, and/or utterance that the user has used.

The user language model 302 may perform an update such that increased weights are given to the input, language, and/or utterance that the user has used, in the candidate response group output from the one or more response decoders 611 and 612.

As the user language model 302 provides the weight to a specific user who uses the interactive messenger architecture 300 or the user's input, language, and/or utterance, the interactive messenger architecture 300 may generate a response, based on the language that the user frequently uses. The user language model 302 may separate, store, and update the weight for each user who uses the interactive messenger architecture 300.

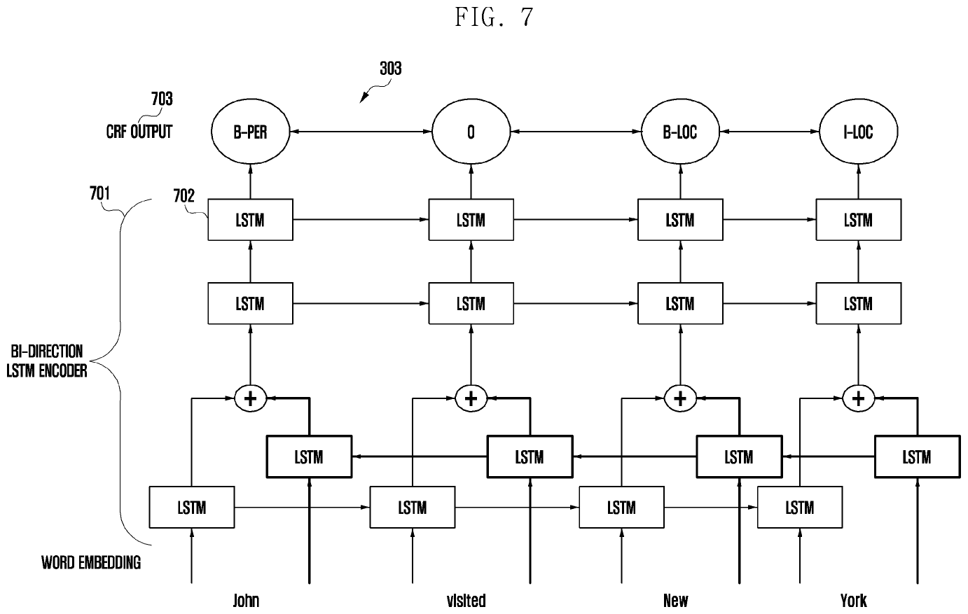

FIG. 7 illustrates an operation of the named entity recognition 303 according to various embodiments.

For example, a method for recognizing, by the named entity recognition 303, a named entity in the IBO format may be as follows. When a named entity with respect to a place name or a human name is extracted from the user's input, language, and/or utterance such as “John visited New York”, “John” or “New”, namely a start of a human name or a place name, may be expressed as “B”, and the human name “John” may be tagged as “B-PER” and the place name “New” may be tagged as “B-LOC”, so that the names may be recognized. A wording “visited” that is not a place name or a human name may be expressed as “O”. In addition, a wording “York” may be expressed as “I”, and the place name “York” may be tagged as “I-LOC”.

An LSTM 702 included in the named entity recognition 303 may be a bi-direction LSTM 701.

The named entity recognition 303 may improve named entity recognition by enabling a CRF layer 703 to be included in an encoding end of the LSTM.

When the named entity recognition 303 extracts and recognizes a named entity from the user's input, language, and/or utterance, the recognized named entity may be transferred to the personal database 304.

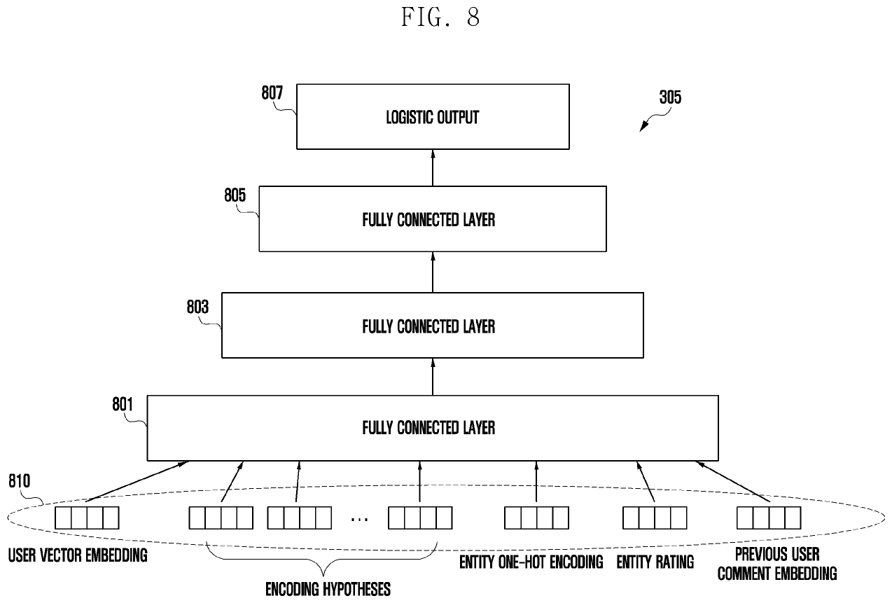

FIG. 8 illustrates an operation of the ranking network 305 according to various embodiments.

The ranking network 305 may include one or more fully connected layers 801, 803, and 805.

The one or more fully connected layers 801, 803, and 805 may successively select a candidate response group in consideration of user vector embedding, a personal database (for example, encoding hypotheses), entity one-hot representation, entity rating, and previous user comment embedding, and finally select a response in a logistic output layer 807.

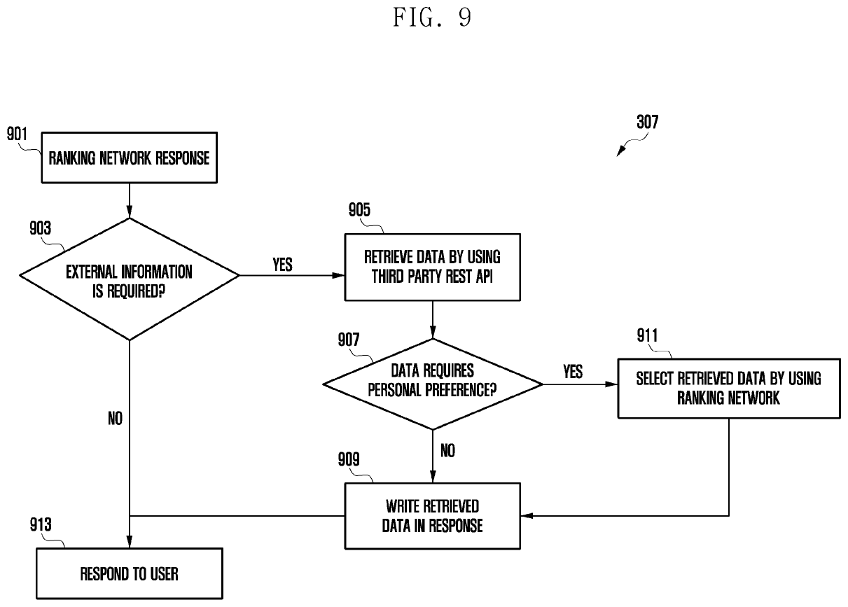

FIG. 9 illustrates an operation of the information retrieval unit 307 according to various embodiments.

In operation 901, the information retrieval unit 307 may receive the response having been selected by the ranking network 305.

In operation 903, the information retrieval unit 307 may determine whether the selected response requires external information.

In operation 903, when it is determined that the selected response does not require external information, the information retrieval unit 307 may perform operation 913.

In operation 913, the information retrieval unit 307 may respond to the user by using the selected response or a response obtained by adding retrieved data to the selected response.

In operation 903, when it is determined that the selected response requires external information, the information retrieval unit 307 may perform operation 905.

In operation 905, the information retrieval unit 307 may retrieve data by using a third party REST API.

In operation 907, the information retrieval unit 307 may determine whether the data having been retrieved using the third party REST API requires personal preference.

In operation 907, when it is determined that the data having been retrieved using the third party REST API does not require personal preference, the information retrieval unit 307 may perform operation 909.

In operation 909, the information retrieval unit 307 may write the retrieved data in the selected response.

In operation 907, when it is determined that the data having been retrieved using the third party REST API requires personal preference, the information retrieval unit 307 may perform operation 911.

In operation 911, the information retrieval unit 307 may select retrieved data by using the ranking network 305 and based on the user vector embedding 306, the personal database 304, and the retrieved data.

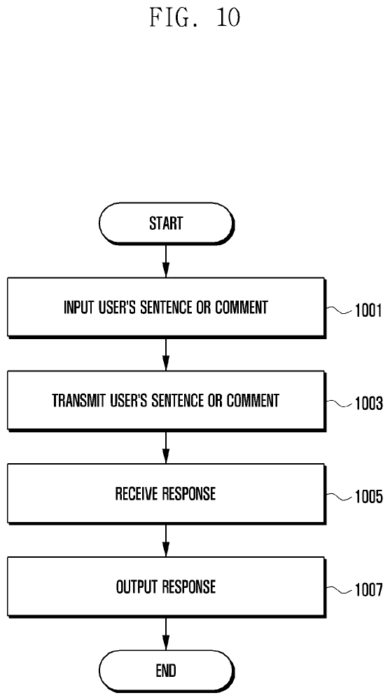

FIG. 10 is a flowchart illustrating an operation of the electronic device 101 which can communicate with the server 108 according to various embodiments.

The server 108 may include the interactive messenger architecture 300. The interactive messenger architecture 300 may be stored in a memory (for example, the memory 130) of the server 108. The interactive messenger architecture 300 may be embedded in a processor (for example, the processor 120) of the server 108.

In operation 1001, the electronic device 101 may receive, as input, the user's sentence or comment through voice input or text input under the control of the processor 120.

In operation 1003, the electronic device 101 may transmit the user's sentence or comment to the server 108 through the communication module 190 under the control of the processor 120.

In operation 1005, the electronic device 101 may receive a response to the user's sentence or comment from the server 108 through the communication module 190 under the control of the processor 120.

In operation 1007, the electronic device 101 may output the received response through the sound output device 155, the display device 160, and/or the audio module 170 under the control of the processor 120.

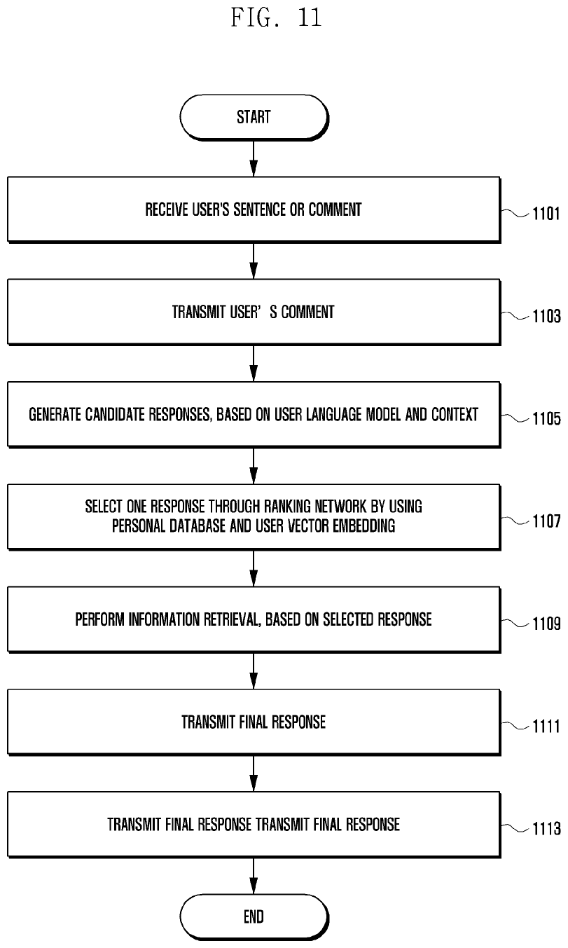

FIG. 11 is a flowchart illustrating an operation of the server 108 which can communicate with the electronic device 101 according to various embodiments.

The server 108 may include the interactive messenger architecture 300. The interactive messenger architecture 300 may be stored in a memory (for example, the memory 130) of the server 108. The interactive messenger architecture 300 may be embedded in a processor (for example, the processor 120) of the server 108.

In operation 1101, the server 108 may receive the user's sentence or comment from the electronic device 101 through a communication module (for example, the communication module 190) under the control of a processor (for example, the processor 120).

In operation 1103, the server 108 may transfer the user's received sentence or comment to the interactive messenger architecture 300 under the control of the processor (for example, the processor 120).

In operation 1105, the server 108 may generate candidate responses by means of the response generator 301, based on the user language model 302 and a context, under the control of the processor (for example, the processor 120).

In operation 1107, the server 108 may select one response from among the candidate responses through the ranking network 305 by using the personal database 304 and the user vector embedding 306, under the control of the processor (for example, the processor 120). In operation 1107, the personal database 304 may be a named entity which has been extracted and/or recognized from the user's sentence or comment through the named entity recognition 303 under the control of the processor (for example, the processor 120).

In operation 1109, the server 108 may perform information retrieval, based on the selected response, under the control of the processor (for example, the processor 120).

In operation 1111, the server 108 may transfer a final response to the electronic device 101 through the communication module (for example, the communication module 190), based on at least one of the selected response and/or data obtained by the information retrieval, under the control of the processor (for example, the processor 120).

In operation 1113, the server 108 may update the user language model 302, the personal database 304, and the user vector embedding 306, under the control of the processor (for example, the processor 120).

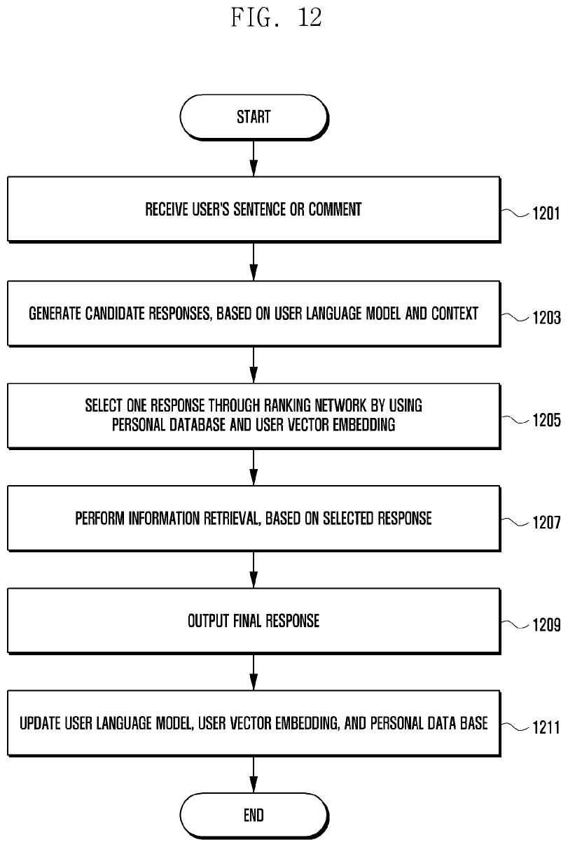

FIG. 12 is a flowchart illustrating an operation of the electronic device 101 according to various embodiments.

The electronic device 101 may include the interactive messenger architecture 300. The interactive messenger architecture 300 may be stored in a memory (for example, the memory 130) of the electronic device 101. The interactive messenger architecture 300 may be embedded in a processor (for example, the processor 120) of the electronic device 101.

In operation 1201, the electronic device 101 may transfer the user's sentence or comment having been acquired by text or voice to the interactive messenger architecture 300 under the control of a processor (for example, the processor 120).

In operation 1203, the electronic device 101 may generate candidate responses by means of the response generator 301, based on the user language model 302 and a context, under the control of the processor (for example, the processor 120).

In operation 1205, the electronic device 101 may select one response from among the candidate responses through the ranking network 305 by using the personal database 304 and the user vector embedding 306, under the control of the processor (for example, the processor 120). In operation 1205, the personal database 304 may be a named entity which has been extracted and/or recognized from the user's sentence or comment through the named entity recognition 303 under the control of the processor (for example, the processor 120).

In operation 1207, the electronic device 101 may perform information retrieval, based on the selected response, under the control of the processor (for example, the processor 120).

In operation 1209, the electronic device 101 may output a final response through the sound output device 155, the display device 160, and/or the audio module 170, based on at least one of the selected response and/or data obtained by the information retrieval, under the control of the processor (for example, the processor 120).

In operation 1211, the electronic device 101 may update the user language model 302, the personal database 304, and the user vector embedding 306, under the control of the processor (for example, the processor 120).

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via another element (e.g., third element).

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. The “module” may be mechanically or electronically implemented. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. An interactive messenger operation method comprising:
transferring a user's sentence or comment to an interactive messenger architecture;
generating candidate responses using a response generator based on a user language model and a context; and
selecting one response from among the candidate responses through a ranking network by using a personal database and a user vector embedding.

2. The method of claim 1, further comprising:
performing information retrieval based on the selected response; and
transferring a final response to an external device based on at least one of the selected response and data obtained by the information retrieval.

3. The method of claim 1, further comprising receiving, as input, the user's sentence or comment as a voice input or a text input.

4. The method of claim 1, further comprising transmitting the user's sentence or comment.

5. The method of claim 1, further comprising:
performing information retrieval based on the selected response;
outputting a final response based on at least one of the selected response and data obtained by the information retrieval; and
updating the user language model, the personal database, and the user vector embedding.

6. The method of claim 5, wherein the performing of the information retrieval based on the selected response further comprises:
performing information retrieval by using a third party service in response to determining that the selected response requires external information;
selecting retrieved data by using the ranking network and based on the user vector embedding, the personal database, and the retrieved data in response to determining whether the retrieved data requires personal preference; and
writing the selected data in the selected response.

7. The method of claim 5, wherein the performing of the information retrieval based on the selected response further comprises outputting the selected response as a final response in response to determining that the selected response does not require external information.

8. The method of claim 5, wherein:
the user language model is a model using an artificial neural network or a method using statistics or a probability, and
the method further comprises performing an update such that increased weights are given to input, language, or utterance, which the user has used.

9. The method of claim 5, wherein a named entity recognition is a sequence labelling network including a long short term memory (LSTM) and a conditional random field (CRF) layer.

10. The method of claim 5, further comprising determining, by the user vector embedding, a similarity between responses based on a response selected by the ranking network.

11. An electronic device comprising:
a display device;
a communication module;
a memory; and
a processor,
wherein the processor is configured to:
transfer a user's sentence or comment to an interactive messenger architecture;
generate candidate responses using a response generator based on a user language model and a context; and
select one response from among the candidate responses through a ranking network by using a personal database and a user vector embedding.

12. The electronic device of claim 11, wherein the processor is further configured to:
perform information retrieval, based on the selected response; and
transfer a final response to an external device, based on at least one of the selected response and data obtained by the information retrieval.

13. The electronic device of claim 11, wherein the processor is further configured to receive, as input, the user's sentence or comment as a voice input or a text input.

14. The electronic device of claim 11, wherein the processor is further configured to transmit the user's sentence or comment through the communication module.

15. The electronic device of claim 11, wherein the processor is further configured to:
perform information retrieval, based on the selected response;
output a final response, based on at least one of the selected response and data obtained by the information retrieval; and
update the user language model, the personal database, and the user vector embedding.

16. The electronic device of claim 15, wherein the processor is further configured to:
perform information retrieval by using a third party service when it is determined that the selected response requires external information;
select retrieved data by using the ranking network and based on the user vector embedding, the personal database, and the retrieved data when it is determined whether the retrieved data requires personal preference; and
write the selected data in the selected response.

17. The electronic device of claim 15, wherein the processor is configured to output the selected response as a final response on the display device, when it is determined that the selected response does not require external information.

18. The electronic device of claim 15, wherein:
the user language model is a model using an artificial neural network and/or a method using statistics or a probability, and
the electronic device performs an update such that increased weights are given to input, language, or utterance, which the user has used.

19. The electronic device of claim 15, wherein a named entity recognition is a sequence labelling network including an LSTM and a CRF layer.

20. The electronic device of claim 15, wherein the user vector embedding determines a similarity between responses, based on a response selected by the ranking network.
